(19) United States
(12) Patent Application Publication
(10) Pub. No.: US 2026/0237881 A1
(43) Pub. Date: Aug. 13, 2026

(54) FLIGHT VEHICLE

(71) Applicant: Sony Group Corporation, Tokyo (JP)

(72) Inventors: Soichiro OYA, Tokyo (JP); Daisuke YOSHIDA, Tokyo (JP); Junpei YAMAUCHI, Tokyo (JP); Sayuri GOTO, Tokyo (JP); Junichi SHINBORI, Tokyo (JP); Noboru NAKAMURA, Tokyo (JP)

(73) Assignee: Sony Group Corporation, Tokyo (JP)

(21) Appl. No.: 19/154,382

(22) PCT Filed: Feb. 8, 2024
(86) PCT No.: PCT/JP2024/004244

§ 371 Date: Aug. 7, 2025

(30) Foreign Application Priority Data
Feb. 20, 2023 (JP) 2023-024536

(51) Int. Cl. H01Q 1/08; B64U 10/14; B64U 20/60; B64U 20/80; F16F 15/08

(52) U.S. Cl. CPC H01Q 1/084; B64U 10/14; B64U 20/60; B64U 20/80; F16F 15/08; F16F 2224/025

(57) ABSTRACT

A flight vehicle of the present disclosure includes a body, a rotary blade that floats the body, a drive mechanism that rotates the rotary blade, and an arm that extends from the body. The arm is foldable from a use state to a storage state, and is automatically locked in the use state when transitioning to the use state.

### FIELD

The present disclosure relates to a flight vehicle.

### BACKGROUND

Conventionally, in a flight vehicle such as a drone, a rotary blade, an antenna, and the like are disposed at a distal end of an arm extending from a body. Some of such arms have a structure capable of being transitioned from a use state to a storage state by being folded (see, for example, Patent Literature 1).

### CITATION LIST

### Patent Literature

Patent Literature 1: JP 2017-197169 A

### SUMMARY

### Technical Problem

The present disclosure proposes a flight vehicle capable of improving usability of an arm.

### Solution to Problem

According to the present disclosure, there is provided a flight vehicle. The flight vehicle includes a body, a rotary blade that floats the body, a drive mechanism that rotates the rotary blade, and an arm that extends from the body. The arm is foldable from a use state to a storage state, and is automatically locked in the use state when transitioning to the use state.

### BRIEF DESCRIPTION OF DRAWINGS

FIG. 1 is a side view showing an example of a use state of a drone according to an embodiment of the present disclosure.

FIG. 2 is a side view showing an example of a storage state of the drone according to the embodiment of the present disclosure.

FIG. 3 is a diagram for describing a configuration and operation of a lock mechanism in the drone according to the embodiment of the present disclosure.

FIG. 4 is a diagram for describing the configuration and operation of the lock mechanism in the drone according to the embodiment of the present disclosure.

FIG. 5 is a diagram for describing the configuration and operation of the lock mechanism in the drone according to the embodiment of the present disclosure.

FIG. 6 is an enlarged sectional view showing an example of a configuration of a rotary shaft and a periphery of the rotary shaft according to an embodiment of the present disclosure.

FIG. 7 is an enlarged sectional view showing an example of an attached state of an arm according to an embodiment of the present disclosure.

### DESCRIPTION OF EMBODIMENTS

Hereinafter, embodiments of the present disclosure will be described with reference to the accompanying drawings. Note that the present disclosure is not limited to the following embodiments. The embodiments can be appropriately combined within a range in which processing contents do not contradict each other. In the following embodiments, the same parts are denoted by the same reference signs, and redundant description will be omitted.

Conventionally, in a flight vehicle such as a drone, a rotary blade, an antenna, and the like are disposed at a distal end of an arm extending from a body. Some of such arms have a structure capable of transitioning from a use state to a storage state by being folded.

On the other hand, in the related art described above, when the arm transitions from the storage state to the use state, the user is required to manually lock the arm in the use state. That is, in the related art, there is room for further improvement in usability of the arm attached to the flight vehicle such as a drone.

It is therefore expected to implement a technique capable of overcoming the above problem and improving the usability of the arm attached to the flight vehicle.

### Configuration Example of Drone

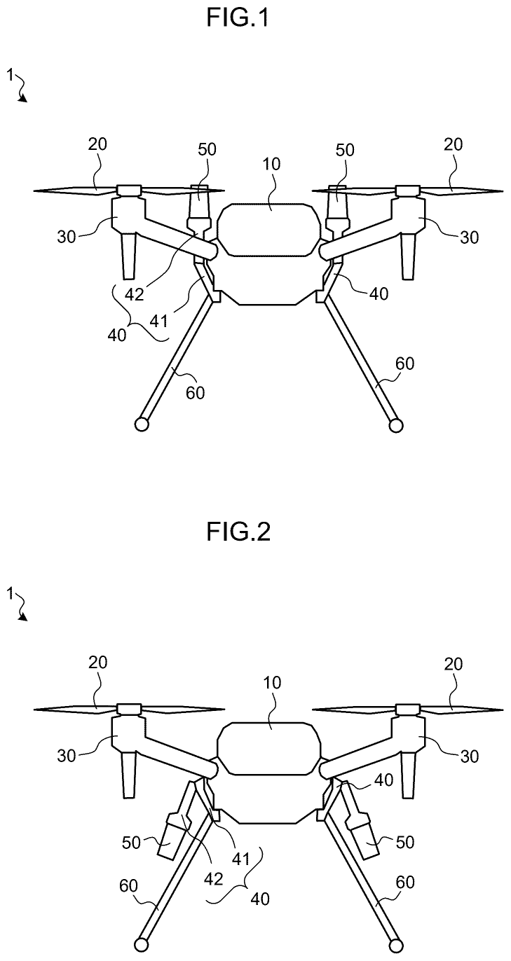

First, an example of a configuration of a drone 1 according to an embodiment will be described with reference to FIGS. 1 and 2. FIG. 1 is a side view showing an example of a use state of the drone 1 according to the embodiment of the present disclosure, and FIG. 2 is a side view showing an example of a storage state of the drone 1 according to the embodiment of the present disclosure.

The drone 1 according to the embodiment is an example of a flight vehicle, and is also referred to as a multicopter or the like. As shown in FIG. 1, the drone 1 includes a body 10, a plurality of rotary blades 20, a plurality of drive mechanisms 30, a plurality of arms 40, a plurality of antennas 50, and a plurality of landing gears 60.

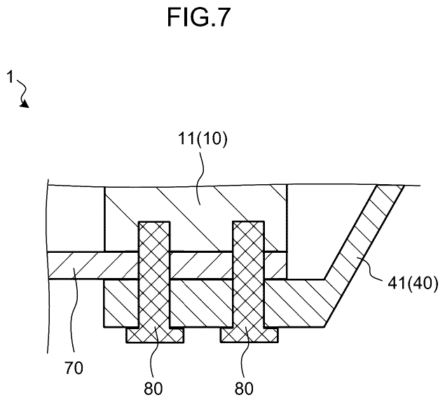

A control device, a camera, a battery (none of which are shown), and the like are mounted on the body 10. The body 10 has a frame 11 (see FIG. 7) including metal. The body 10 is located, for example, in a center of the drone 1 in plan view.

The rotary blade 20 floats the body 10. Specifically, the rotary blade 20 rotates to generate lift for floating the body 10. In the present disclosure, for example, the plurality of rotary blades 20 is located so as to surround the body 10 in plan view.

The drive mechanism 30 is, for example, a motor, and rotates the rotary blade 20. In the present disclosure, for example, a plurality of drive mechanisms 30 is provided in each of the plurality of rotary blades 20.

In the present disclosure, for example, the drone 1 flies by supplying electric power from the battery of the body 10 to each of the plurality of drive mechanisms 30 and rotating each of the plurality of rotary blades 20.

The control device can implement hovering flight and forward, backward, leftward, and rightward moving flight of the drone 1 by controlling a rotation speed of each of the plurality of rotary blades 20 and balancing the lift obtained by the rotation of the rotary blades 20 with the gravity of the drone 1.

Furthermore, the control device can raise the drone 1 by increasing the lift obtained by the plurality of rotary blades 20, and can lower the drone 1 by decreasing the lift obtained by the plurality of rotary blades 20.

The arm 40 extends from the body 10. The arm 40 includes a first arm 41 on a proximal end side and a second arm 42 on a distal end side. The first arm 41 is fixed to, for example, the frame 11 on a lower side of the body 10. The second arm 42 is pivotally supported by a distal end of the first arm 41.

As described above, since the second arm 42 is pivotally supported to the first arm 41, the arm 40 is foldable from the use state shown in FIG. 1 to the storage state shown in FIG. 2. For example, the second arm 42 extends upward from the distal end of the first arm 41 in the use state, and extends downward from the distal end of the first arm 41 in the storage state.

Note that, in the present disclosure, the “upper side (upward)” refers to an upper side in a flight state of the drone 1, and the “lower side (downward)” refers to a lower side in the flight state of the drone 1.

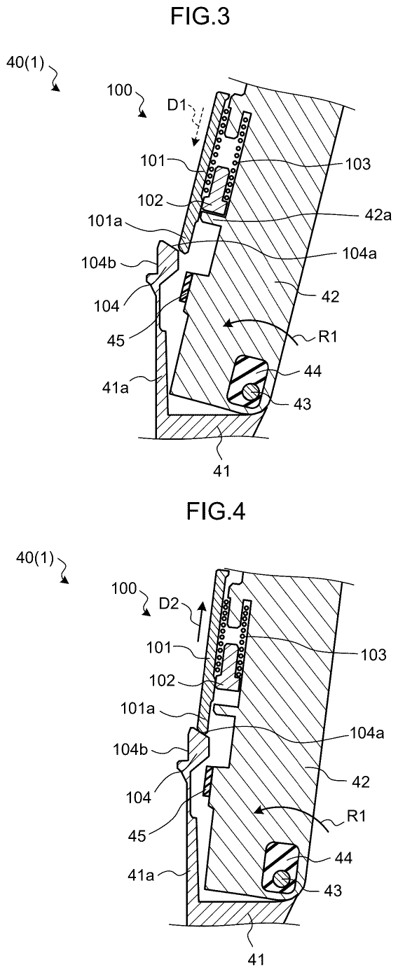

The arm 40 according to the embodiment is provided with a lock mechanism 100 (see FIG. 3) that automatically locks the second arm 42 when the second arm 42 transitions from a state other than the use state (for example, the storage state) to the use state. Details of the lock mechanism 100 will be described later.

The antenna 50 is located, for example, at a distal end of the arm 40 (that is, a distal end of the second arm 42). The antenna 50 is, for example, a real time kinematic (RTK)-global navigation satellite system (GNSS) antenna. By providing the RTK-GNSS antenna on the drone 1, the position of the drone 1 in flight can be measured in real time in units of several centimeters of error.

Note that, in the present disclosure, the antenna 50 is not limited to the RTK-GNSS antenna, and may be another type of antenna. In the present disclosure, an instrument attached to the arm 40 is not limited to an antenna, and may be an instrument other than an antenna (for example, a rotary blade or the like).

The landing gear 60 supports the body 10 when the drone 1 lands. For example, the landing gear 60 is provided on a lower side of the body 10. When the drone 1 lands, a distal end of the landing gear 60 abuts on the ground or the like, and the body 10 is thus supported.

### Details of Lock Mechanism

Next, details of the lock mechanism 100 provided in the arm 40 will be described with reference to FIGS. 3 to 5. FIGS. 3 to 5 are diagrams for describing a configuration and operation of the lock mechanism 100 in the drone 1 according to the embodiment of the present disclosure. FIG. 3 is a diagram showing a state immediately before the arm 40 is put into the use state.

As shown in FIG. 3, the arm 40 according to the embodiment includes a rotary shaft 43, a torque application member 44, a first vibration damper 45, and the lock mechanism 100 in addition to the first arm 41 and the second arm 42 described above. The first vibration damper 45 is an example of a vibration damper.

The rotary shaft 43 fixes and supports the second arm 42 to the first arm 41 pivotally about a predetermined rotary axis. The rotary shaft 43 has a rod shape, for example, and is inserted into a hole 41b (see FIG. 6) formed in the first arm 41 and a hole 42b (see FIG. 6) formed in the second arm 42.

The torque application member 44 applies torque to the second arm 42 when the second arm 42 pivots. The torque application member 44 includes, for example, an elastic member such as rubber, is press-fitted into the second arm 42, and is located so as to be in contact with the rotary shaft 43.

As described above, since the press-fitted torque application member 44 is located so as to be in contact with the rotary shaft 43, friction occurs between the torque application member 44 and the rotary shaft 43 when the second arm 42 pivots, and thus torque can be applied to the second arm 42.

As a result, even when the drone 1 is transported with the arm 40 in the storage state (see FIG. 2), it is possible to suppress inadvertent movement of the second arm 42 and the antenna 50 (see FIG. 1). Therefore, the embodiment can improve durability and reliability of the antenna 50 and the like.

In the embodiment, even when the drone 1 is turned upside down at the time of attaching the landing gear 60 (see FIG. 1), the second arm 42 can be prevented from inadvertently moving, and maintainability of the drone 1 can be improved.

When the second arm 42 transitions to the use state, the lock mechanism 100 automatically fixes the second arm 42 to the first arm 41. The lock mechanism 100 includes a lock slider 101, a lock holder 102, a biasing member 103, and an abutting portion 104.

The lock slider 101 is supported by the second arm 42 to be slidable toward a joint between the first arm 41 and the second arm 42. Specifically, the lock slider 101 is supported by the second arm 42 and is slidable along a direction D1 along a direction in which the second arm 42 extends and along a direction D2 (see FIG. 4) opposite to the direction D1.

The direction D1 is a direction toward the joint between the first arm 41 and the second arm 42, and the direction D2 is a direction away from the joint between the first arm 41 and the second arm 42.

The lock holder 102 is fixed to the second arm 42 of the lock slider 101 by a fastening member (not illustrated) such as a screw. That is, the lock holder 102 is supported together with the lock slider 101 to be slidable along the predetermined directions D1 and D2 with respect to the second arm 42.

The biasing member 103 is, for example, a spring, and biases the lock slider 101 and the lock holder 102 toward the joint between the first arm 41 and the second arm 42. Specifically, the biasing member 103 biases the lock slider 101 toward the direction D1 by applying a biasing force toward the direction D1 to the lock holder 102.

The position in the direction D1 of the lock slider 101 and the lock holder 102 biased in the direction D1 is restricted by abutting on a protrusion 42a protruding toward the direction D1 of the lock holder 102 in the second arm 42.

The abutting portion 104 is provided at a position corresponding to the lock slider 101 in the first arm 41, and can abut on a distal end 101a of the lock slider 101 in the direction D1. The abutting portion 104 is located, for example, at a distal end of a wall 41a of the first arm 41. The wall 41a is located so as to face the second arm 42 in a rotation direction R1 of the second arm 42.

Then, in the embodiment, as shown in FIG. 3, when the second arm 42 pivots in the predetermined rotation direction R1 immediately before the arm 40 transitions to the use state, the distal end 101a of the lock slider 101 and a pressing portion 104a of the abutting portion 104 abuts on each other.

The pressing portion 104a is, for example, an inclined surface provided on the second arm 42 of the abutting portion 104, and is inclined so as to approach the lock slider 101 in the rotation direction R1.

Then, when the second arm 42 further pivots in the rotation direction R1 from the state shown in FIG. 3, the pressing portion 104a presses the lock slider 101 in the direction D2. As a result, as shown in FIG. 4, the lock slider 101 and the lock holder 102 move in the direction D2.

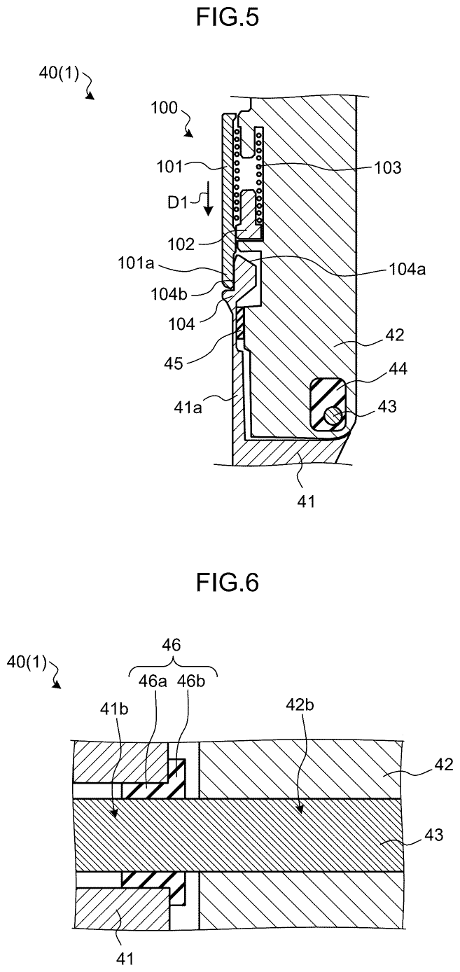

Then, when the second arm 42 further pivots in the rotation direction R1 from the state of FIG. 4, as illustrated in FIG. 5, the lock slider 101 that has passed over the pressing portion 104a is biased in the direction D1 by the biasing member 103 to be accommodated in an accommodating portion 104b of the abutting portion 104.

The accommodating portion 104b has a wall surface provided on the rotation direction R1 of the abutting portion 104, accommodates the lock slider 101 when the arm 40 transitions to the use state, and prevents the second arm 42 from pivoting in the direction opposite to the rotation direction R1.

When the lock slider 101 is accommodated in the accommodating portion 104b, the second arm 42 abuts on the wall 41a of the first arm 41 via the first vibration damper 45. This configuration prevents the second arm 42 from pivoting in the rotation direction R1.

As described above, in the embodiment, when the arm 40 including the lock mechanism 100 transitions to the use state, the second arm 42 is automatically fixed to the first arm 41 without a user's trouble.

Therefore, the embodiment can improve usability of the arm 40 attached to the drone 1.

In the embodiment, since the lock mechanism 100 includes three members, namely, the lock slider 101, the lock holder 102, and the biasing member 103, the second arm 42 can be automatically locked with a space-saving and lightweight mechanism.

Note that the lock mechanism 100 according to the embodiment is not limited to the configuration shown in the example in FIGS. 3 to 5, and may be any mechanism as long as the second arm 42 is automatically fixed to the first arm 41 when the arm 40 transitions to the use state.

In the embodiment, when the arm 40 transitions to the use state, the first vibration damper 45 may be located between the wall 41a of the first arm 41 and the second arm 42. The first vibration damper 45 includes an elastic member such as rubber, for example, and suppresses transmission of vibration from the first arm 41 to the second arm 42.

It is therefore possible to suppress transmission of vibration caused by rotation of the rotary blade 20 (see FIG. 1) or the like from the first arm 41 to the second arm 42. Therefore, the embodiment can improve the durability and reliability of the antenna 50 and components (for example, a quartz oscillator and the like) accompanying the antenna 50.

In the example in FIGS. 3 to 5, an example has been described in which the first vibration damper 45 is attached to the second arm 42, but the present disclosure is not limited to such an example. For example, the first vibration damper 45 may be attached to the first arm 41, or may be attached to both the first arm 41 and the second arm 42.

In the embodiment, the lock slider 101 and the lock holder 102, which are formed as separate members, can be more easily attached to the second arm 42 than in a case where the lock slider 101 and the lock holder 102 are integrally formed.

In the present disclosure, the lock slider 101 and the lock holder 102 are not required to be formed as separate members, and the lock slider 101 and the lock holder 102 may be integrally formed.

In a case where the arm 40 according to the embodiment transitions from the use state to the storage state, the user is only required to move the lock slider 101 in the direction D2, and then pivot the second arm 42 in a rotation direction opposite to the rotation direction R1. As a result, since the lock slider 101 is detached from the abutting portion 104, the user can freely pivot the second arm 42 toward a position to be accommodated.

In the example in FIGS. 3 to 5, an example has been described in which the lock slider 101, the lock holder 102, and the biasing member 103 are provided in the second arm 42, and the abutting portion 104 is provided in the first arm 41. However, the present disclosure is not limited to such an example.

For example, the lock slider 101, the lock holder 102, and the biasing member 103 may be provided in the first arm 41, and the abutting portion 104 may be provided in the second arm 42. In this case, too, when the arm 40 transitions to the use state, the second arm 42 is automatically fixed to the first arm 41 without the user's trouble.

### Configuration of Other Portions

Next, a configuration of parts other than the lock mechanism 100 in the arm 40 will be described with reference to FIGS. 6 and 7. FIG. 6 is an enlarged sectional view showing an example of a configuration of the rotary shaft 43 and a periphery of the rotary shaft according to the embodiment of the present disclosure.

As shown in FIG. 6, in the embodiment, the rod-shaped rotary shaft 43 is inserted into the hole 41b formed in the first arm 41 and the hole 42b formed in the second arm 42.

In the embodiment, a second vibration damper 46 is provided on the rotary shaft 43. The second vibration damper 46 is an example of a vibration damper, and includes, for example, an elastic member such as rubber.

The second vibration damper 46 includes a tube 46a and an annular portion 46b. The tube 46a has, for example, a tubular shape and is located between the first arm 41 and the rotary shaft 43. The annular portion 46b has, for example, an annular shape and is located between the first arm 41 and the second arm 42.

Since the second vibration damper 46 is provided, transmission of vibration from the first arm 41 to the second arm 42 via the rotary shaft 43 can be suppressed. The embodiment can suppress transmission of vibration caused by rotation of the rotary blade 20 (see FIG. 1) or the like from the first arm 41 to the second arm 42.

Therefore, the embodiment can improve the durability and reliability of the antenna 50 (see FIG. 1) and components (for example, a quartz oscillator or the like) accompanying the antenna 50.

FIG. 7 is an enlarged sectional view showing an example of an attached state of the arm 40 according to an embodiment of the present disclosure. As shown in FIG. 7, the arm 40 may be fastened to the frame 11 on the lower side of the body 10 together with a fastening member 80 which is the same as a member 70 different from the arm 40. The member 70 is, for example, a gimbal fixing plate for fixing a gimbal.

In this manner, by fastening the arm 40 together with the other member 70, the number of fastening members 80 used for the drone 1 can be reduced, and the drone 1 can be reduced in weight. Note that the member 70 fastened together with the arm 40 is not limited to the gimbal fixing plate, and may be another member provided in the drone 1.

In the embodiment, since the arm 40 is fixed to the frame 11, which includes a magnesium alloy or the like and is highly rigid, the position of the antenna 50 (see FIG. 1) is stabilized when the drone 1 is in flight. Therefore, the embodiment can accurately measure the position of the drone 1 in flight.

In the embodiment, as shown in FIG. 1, the arm 40 is preferably fixed to the frame 11 on the lower side of the body 10 and extends upward. In this manner, radio waves from navigation satellites can be efficiently received, and the antenna 50 can be separated from the metal frame 11. Therefore, the embodiment can accurately measure the position of the drone 1 in flight.

### Effects

The flight vehicle (drone 1) according to the embodiment includes the body 10, the rotary blade 20 that floats the body 10, the drive mechanism 30 that rotates the rotary blade 20, and the arm 40 that extends from the body 10. The arm 40 is foldable from the use state to the storage state, and is automatically locked in the use state when transitioning to the use state.

This configuration can improve the usability of the arm 40 attached to the drone 1.

The flight vehicle (drone 1) according to the embodiment further includes the antenna 50 located at the distal end of the arm 40.

As a result, the drone 1 can efficiently receive radio waves.

In the flight vehicle (drone 1) according to the embodiment, the antenna 50 is an RTK-GNSS antenna.

Accordingly, the position of the drone 1 in flight can be measured in real time in units of several centimeters of error.

In the flight vehicle (drone 1) according to the embodiment, the arm 40 includes the first arm 41 on the proximal end side, the second arm 42 on the distal end side, the rotary shaft 43, and the lock mechanism 100. The rotary shaft 43 pivotally supports the second arm 42 around a predetermined rotary axis with respect to the first arm 41. At the time of transition to the use state, the lock mechanism 100 automatically fixes the second arm 42 to the first arm 41.

This configuration can improve the usability of the arm 40 attached to the drone 1.

In the flight vehicle (drone 1) according to the embodiment, the lock mechanism 100 includes the lock slider 101, the biasing member 103, and the abutting portion 104. The lock slider 101 is supported by the second arm 42 to be slidable toward a joint between the first arm 41 and the second arm 42. The biasing member 103 biases the lock slider 101 toward the joint. The abutting portion 104 is provided at a position corresponding to the lock slider 101 in the first arm 41. The abutting portion 104 includes the pressing portion 104a and the accommodating portion 104b. The pressing portion 104a presses the lock slider 101 in a direction away from the joint (direction D2) immediately before transition to the use state. The accommodating portion 104b accommodates the lock slider 101 biased toward the joint at the time of transition to the use state to prevent the second arm 42 from pivoting.

As a result, the second arm 42 can be automatically locked with a space-saving and lightweight mechanism.

In the flight vehicle (drone 1) according to the embodiment, the lock mechanism 100 includes the lock holder 102 that is fixed to the lock slider 101 and receives the biasing force from the biasing member 103.

As a result, the lock holder 102 and the lock slider 101 can be easily attached to the second arm 42.

In the flight vehicle (drone 1) according to the embodiment, the arm 40 includes the vibration damper (first vibration damper 45). The vibration damper (first vibration damper 45) is positioned between the first arm 41 and the second arm 42 after transition to the use state, and suppresses transmission of vibration from the first arm 41 to the second arm 42.

This configuration can improve the durability and reliability of the antenna 50 and components (for example, a quartz oscillator and the like) accompanying the antenna 50.

In the flight vehicle (drone 1) according to the embodiment, the rotary shaft 43 includes the vibration damper (second vibration damper 46). The vibration damper (second vibration damper 46) suppresses transmission of vibration from the first arm 41 to the second arm 42.

This configuration can improve the durability and reliability of the antenna 50 and components (for example, a quartz oscillator and the like) accompanying the antenna 50.

In the flight vehicle (drone 1) according to the embodiment, the rotary shaft 43 includes the torque application member 44 that applies torque to the second arm 42 when the second arm 42 pivots.

This configuration can improve the durability and reliability of the antenna 50 and the like and the maintainability of the drone 1.

In the flight vehicle (drone 1) according to the embodiment, the body 10 has the frame 11 including metal. The arm 40 is fixed to the frame 11 on the lower side and extends upward.

Therefore, the position of the drone 1 in flight can be measured accurately.

In the flight vehicle (drone 1) according to the embodiment, the arm 40 is fastened together with the member 70 different from the arm and fixed to the frame 11.

As a result, the drone 1 can be reduced in weight.

Although the embodiments of the present disclosure have been described above, the technical scope of the present disclosure is not limited to the embodiments as they are, and various changes can be made without departing from the gist of the present disclosure. The constituent elements of different embodiments and modifications may be appropriately combined.

For example, in the embodiment, an example has been described in which the flight vehicle provided with the arm 40 is a drone. However, the present disclosure is not limited to such an example, and the flight vehicle may be other than a drone.

In the embodiment, an example has been described in which the arm 40 is divided into two, that is, the first arm 41 and the second arm 42. However, the present disclosure is not limited to such an example, and the arm 40 may be divided into three or more. As a result, the lock mechanism 100 of the present disclosure is provided at at least one of the joints between the divided arms adjacent to each other, and thus, the usability of the arm 40 can be improved.

The effects described in this specification are merely examples and are not limited, and other effects may be provided.

Note that the present technique can also have the following configurations.

(1)

A flight vehicle comprising:
a body;
a rotary blade that floats the body;
a drive mechanism that rotates the rotary blade; and
an arm that extends from the body, wherein
the arm is foldable from a use state to a storage state, and is automatically locked in the use state when transitioning to the use state.

(2)

The flight vehicle according to the above (1), further comprising
an antenna located at a distal end of the arm.

(3)

The flight vehicle according to the above (2), wherein
the antenna is a real time kinematic (RTK)-global navigation satellite system (GNSS) antenna.

(4)

The flight vehicle according to any one of the above (1) to (3), wherein
the arm includes
a first arm on a proximal end side,
a second arm on a distal end side,
a rotary shaft that fixes and supports the second arm to the first arm pivotally around a predetermined rotation axis, and
a lock mechanism that automatically fixes the second arm to the first arm at a time of transition to the use state.

(5)

The flight vehicle according to the above (4), wherein the lock mechanism includes
a lock slider supported in the second arm to be slidable toward a joint between the first arm and the second arm,
a biasing member that biases the lock slider toward the joint, and
an abutting portion provided at a position corresponding to the lock slider in the first arm, and
the abutting portion includes
a pressing portion that presses the lock slider in a direction away from the joint immediately before the transition to the use state, and
an accommodating portion that accommodates the lock slider biased toward the joint at a time of the transition to the use state to prevent the second arm from pivoting.

(6)

The flight vehicle according to the above (5), wherein
the lock mechanism includes a lock holder that is fixed to the lock slider and receives a biasing force from the biasing member.

(7)

The flight vehicle according to any one of the above (4) to (6), wherein
the arm is located between the first arm and the second arm when transitioning to the use state, and
includes a vibration damper that suppresses transmission of vibration from the first arm to the second arm.

(8)

The flight vehicle according to any one of the above (4) to (7), wherein
the rotary shaft includes a vibration damper that suppresses the transmission of the vibration from the first arm to the second arm.

(9)

The flight vehicle according to any one of the above (4) to (8), wherein
the rotary shaft includes a torque application member that applies torque to the second arm when the second arm pivots.

(10)

The flight vehicle according to any one of the above (1) to (9), wherein
the body has a frame including metal, and
the arm is fixed to the frame on a lower side and extends upward.

(11)

The flight vehicle according to the above (10), wherein
the arm is fastened together with a member different from the arm and is fixed to the frame.

### REFERENCE SIGNS LIST

1 DRONE (EXAMPLE OF FLIGHT VEHICLE)
10 BODY
11 FRAME
20 ROTARY BLADE
30 DRIVE MECHANISM
40 ARM
41 FIRST ARM
42 SECOND ARM
43 ROTARY SHAFT
44 TORQUE APPLICATION MEMBER
45 FIRST VIBRATION DAMPER (EXAMPLE OF VIBRATION DAMPER)
46 SECOND VIBRATION DAMPER (EXAMPLE OF VIBRATION DAMPER)
50 ANTENNA
70 MEMBER
100 LOCK MECHANISM
101 LOCK SLIDER
102 LOCK HOLDER
103 BIASING MEMBER
104 ABUTTING PORTION
104a PRESSING PORTION
104b ACCOMMODATING PORTION

1. A flight vehicle comprising:
a body;
a rotary blade that floats the body;
a drive mechanism that rotates the rotary blade; and
an arm that extends from the body, wherein
the arm is foldable from a use state to a storage state, and is automatically locked in the use state when transitioning to the use state.

2. The flight vehicle according to claim 1, further comprising
an antenna located at a distal end of the arm.

3. The flight vehicle according to claim 2, wherein
the antenna is a real time kinematic (RTK)-global navigation satellite system (GNSS) antenna.

4. The flight vehicle according to claim 1, wherein
the arm includes
a first arm on a proximal end side,
a second arm on a distal end side,
a rotary shaft that fixes and supports the second arm to the first arm pivotally around a predetermined rotation axis, and
a lock mechanism that automatically fixes the second arm to the first arm at a time of transition to the use state.

5. The flight vehicle according to claim 4, wherein
the lock mechanism includes
a lock slider supported in the second arm to be slidable toward a joint between the first arm and the second arm,
a biasing member that biases the lock slider toward the joint, and
an abutting portion provided at a position corresponding to the lock slider in the first arm, and
the abutting portion includes
a pressing portion that presses the lock slider in a direction away from the joint immediately before the transition to the use state, and
an accommodating portion that accommodates the lock slider biased toward the joint at a time of the transition to the use state to prevent the second arm from pivoting.

6. The flight vehicle according to claim 5, wherein
the lock mechanism includes a lock holder that is fixed to the lock slider and receives a biasing force from the biasing member.

7. The flight vehicle according to claim 4, wherein
the arm is located between the first arm and the second arm when transitioning to the use state, and
includes a vibration damper that suppresses transmission of vibration from the first arm to the second arm.

8. The flight vehicle according to claim 4, wherein
the rotary shaft includes a vibration damper that suppresses the transmission of the vibration from the first arm to the second arm.

9. The flight vehicle according to claim 4, wherein
the rotary shaft includes a torque application member that applies torque to the second arm when the second arm pivots.

10. The flight vehicle according to claim 1, wherein
the body has a frame including metal, and
the arm is fixed to the frame on a lower side and extends upward.

11. The flight vehicle according to claim 10, wherein
the arm is fastened together with a member different from the arm and is fixed to the frame.
